(19) United States
(12) Patent Application Publication
(10) Pub. No.: US 2004/0173660 A1
(43) Pub. Date: Sep. 9, 2004

(54) Method of soldering

(76) Inventors: Kevin Joseph Lodge, Northants (GB); Giles Humpston, San Jose, CA (US); James Vincent, Milton Keynes (GB)

Correspondence Address: LAHIVE & COCKFIELD, LLP., 28 STATE STREET, BOSTON, MA, 02109, US

(21) Appl. No.: 10/468,977

(22) PCT Filed: Jan. 29, 2002
(86) PCT No.: PCT/GB02/00393

(30) Foreign Application Priority Data
Feb. 24, 2001 (GB) 0104577.2

(51) Int. Cl. B23K 35/12

(52) U.S. Cl. 228/56.3; 228/245

(57) ABSTRACT

In a method of soldering the surfaces of a component (11) to a substrate (12), a solder preform (15) is located in the gap between the surfaces. The solder is heated and an over pressure applied to move the surfaces together whilst the solder is molten. Abutments (17) between the surfaces limit the spacing between them. A trapped void (18) is decreased in volume as the pressure is applied. The method is particularly applicable to monolithic microwave integrated circuits (MMIC) and reduces void areas in joints.

This invention relates to soldering and in particular to soldering of electronic components in integrated circuitry.

Modern microwave systems make extensive use of monolithic microwave integrated circuits (MMIC) in their construction. For high reliability applications the MMIC's will commonly be attached by soldering to a substrate and to accomplish this the faying surfaces to be soldered are provided with gold surfaces. A gold/tin eutectic solder is then normally used to make the joint. The conventional method of introducing the solder into the joint is in the form of foil. The joint must be made without the use of flux since the flux may have a detrimental effect on the service life of the components being joined. The process of soldering without flux suffers a major problem in that voids are commonly found in the soldered joints. In recognition of this, some specifications permit up to 50% voids in soldered joints.

The presence of voids is a particularly acute problem with MMIC power amplifiers which have a large die and it is necessary to achieve a low thermal impedance between the die and heat sink since the service life is reduced by high operating temperatures. A particular problem with MMIC's is the common use of a large number of blind vias in the circuitry which give rise to voids associated with the open ends of each via which are exposed to the joint. These voids may be due to entrapped air in the via which expands during the application of heat for the soldering process and the presence of absorbed water or other materials which become gaseous during heating. The resultant gas pressure increases until it exceeds the hydrostatic pressure of the molten solder and displaces the solder, but typically insufficiently to allow escape of the gases.

Various methods have been used to ameliorate the problem, for example a) heating under vacuum during soldering, b) scrubbing of the die, c) the use of novel shaped preforms, and d) the alternative use of silver-loaded epoxy resin adhesives. These methods do not reliably reduce voids associated with blind vias and may have other disadvantages.

The object of the present invention is to provide a method of soldering which reduces voids in soldering.

According to the present invention there is provided a method of soldering two surfaces together, the method comprising locating a solder preform in a gap between opposed areas to be joined, heating the surfaces and preform to melt the solder, moving said surfaces together whilst the solder is molten, and providing abutments between said surfaces to limit the coming together of the two surfaces during the process.

In one embodiment, an over pressure is applied to move the surfaces together whilst the solder is molten.

In one embodiment, the abutments are provided by spacers having a thickness less than the preform and introduced between the two surfaces prior to melting the solder.

In an alternative embodiment, the spacers are formed as part of the solder preform and are made of a compatible solder having a higher melting point than the planar preform body. The difference in melting points should be at least 10 degrees Celsius and the two solders should be compatible in that the overall characteristics of the preform should not be adversely affected e.g fluidity, strength and conductivity. The higher melting point solder can alloy with the lower temperature solder.

The invention also relates to a soldered assembly having a soldered joint formed by a method according to the present invention.

Yet another aspect of the invention provides a solder preform comprising a substantially planar body made from a first solder with raised abutments on at least one side thereof made from a second compatible solder having a higher melting point.

The invention will be described by way of example and with reference to the accompanying drawings in which:

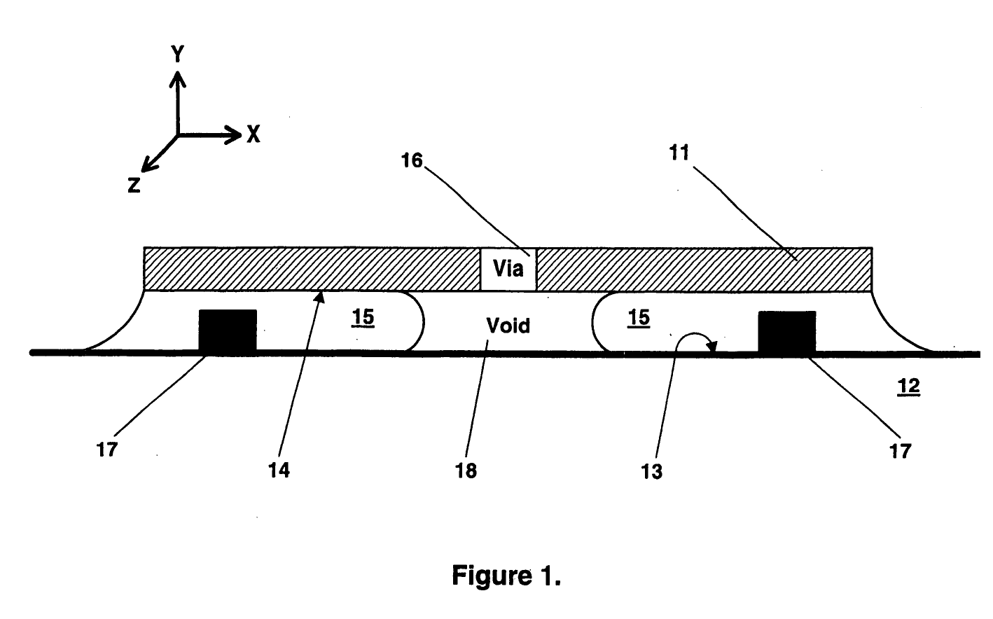

FIG. 1 is a schematic drawing of a method of making a component solder joint according to a first aspect of the invention prior to the application of pressure,

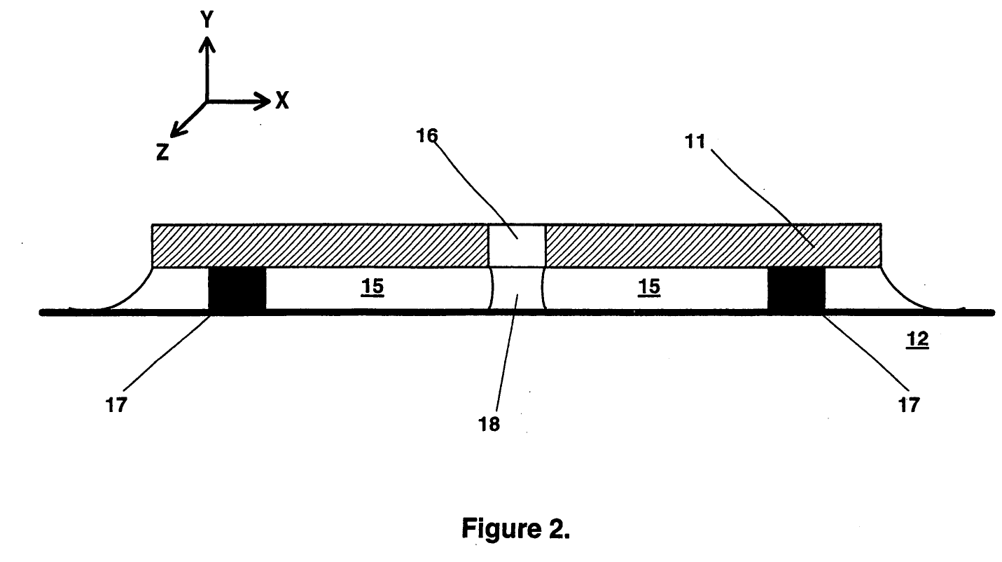

FIG. 2 is shows the joint of FIG. 1 after soldering.

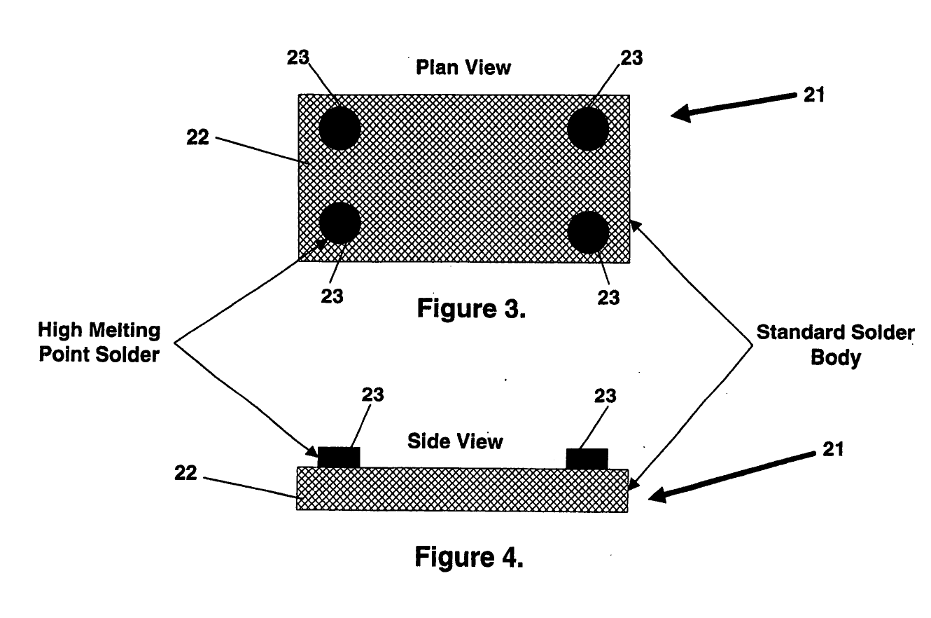

FIG. 3 is a schematic plan of a solder preform used in a second method according to the invention, and

FIG. 4 is a side view of the preform shown in FIG. 3.

With reference to FIG. 1 and FIG. 2, there is shown a component 11, typically an MMIC power amplifier which is to be soldered to a substrate 12. The MMIC has a via 16 and is soldered using a suitable solder for example a Au-20Sn solder eutectic which melts at 280 degrees Celsius. The solder 15 is introduced between the two surfaces 13 14 to be soldered in the form of a solder foil preform.

Abutments 17 in the form of stops are located between the surfaces around the preform. The stops 17 have less height the thickness of the preform. The stops can be provided in any suitable manner eg. as discrete stops, raised abutment surfaces on either or both surfaces, etc.

The assembly is heated and the solder melted and an over pressure atmosphere applied which exerts a load on the molten solder and MMIC. “Over pressure” means a pressure greater than atmospheric pressure. Once the MMIC has bottomed on the stops 17, as shown in FIG. 2, the solder 15 is effectively subject to pressure along two axes only, i.e X & Z and any additional pressure change thereafter acts directly on the trapped void 18 decreasing its volume and hence its cross-sectional area

This approach provides a means of controlling the void area in the XZ plane by maintaining a fixed Y axis dimension as the over pressure increases. This relationship is predictable and can be calculated. As compared with a conventional over pressure is change process without abutments, the percentage voids in the XZ plane can be greatly reduced.

In a second embodiment of the invention, the problem of allowing entrapped gases to escape is provided for by maintaining a joint gap for some time after the component 11 and solder have reached melt temperature. To this end, there is provided a solder preform 21 as shown in FIGS. 3 & 4. The preform 21 has a planar body 22 made from a first solder having a first melting point, and stops 23 located on one side of the body and made of a second higher melting point solder.

The solder preform body may be any desired shape and the stops 23 are of sufficient number, dimensions, and arrangement so as to provide ease of jigging for the solder process.

The second higher melting point solder must be compatible with the solder of the body. Suitable combinations are given in Table 1 below:

TABLE 1

| Body Solder+ | Melting* point | Stop Solder+ | Melting* point |
|---|---|---|---|
| Au—20Sn | 280 | Au—12Ge | 361 |
| Sn—3Ag | 221 | Sn | 232 |
| In—48Sn | 120 | In | 157 |

*all melting points in degrees Celsius
+all compositions in weight percentages

The differences in melting points should be at least 10 degrees Celsius.

The assembly to be soldered is heated to the standard peak processing temperature for the body which will be below the melting point of the stop. The surface tension of the lower temperature solder supports the stop 23 which holds the MMIC clear of the molten solder allowing the gases and moisture in the vias to escape through the gap between the MMIC and the solder. The higher temperature stops 23 are consumed by alloying until the MMIC sinks down onto the molten solder and joining is completed in the traditional manner.

1. A method of soldering two surfaces together, the method comprising locating a solder preform in a gap between opposed areas to be joined, heating the surfaces and preform to melt the solder, moving said surfaces together whilst the solder is molten, and providing abutments between said surfaces to limit the coming together of the two surfaces during the process.

2. A method as claimed in claim 1 wherein the abutments are provided by spacers having a thickness less than the preform and introduced between said two surfaces prior to melting the solder.

3. A method as claimed in claim 1 wherein the coming together of the two surfaces is limited only during a first stage of the soldering process.

4. A method as claimed in claim 3 wherein the spacers are part of the solder preform and are made of a solder having a higher melting point than the body of preform.

5. A method as claimed in claim 4 wherein the spacers have a melting point at least 10 degrees Celsius above that of the body.

6. A method as claimed in claim 4 or claim 5 wherein the two solders are compatible and the higher melting point solder can alloy with the lower temperature solder.

7. A method as claimed in claim 6 wherein the preform body is made from a low melting point indium based solder and the spacer is made from indium solder.

8. A method as claimed in claim 6 wherein the preform body is made from Sn-3Ag solder and the spacer is made from tin solder.

9. A method as claimed in claim 6 wherein the preform body is made from Au-20Sn solder and the spacer is made from Au-12Ge solder.

10. A method as claimed in any one of claims 1 to 9 wherein an over pressure is applied to the solder joint whilst molten.

11. A method of soldering a monolithic microwave integrated circuit to a carrier including a method as claimed in any preceding claim.

12. A soldered assembly having at least one solder joint formed by a method as claimed in any one of claims 1 to 11.

13. A solder preform comprising a substantially planar body made from a first solder with raised abutments on at least one side thereof made from a second compatible solder having a higher melting point.
